(19) United States
(12) Patent Application Publication
(10) Pub. No.: US 2022/0078899 A1
(43) Pub. Date: Mar. 10, 2022

(54) MAGNETIC CONTAINMENT FIELD GENERATING DISCRETE REDUNDANCY DEVICE

(71) Applicant: Dmytro Vladimirovich Poluektov, Seattle, WA (US)

(72) Inventor: Dmytro Vladimirovich Poluektov, Seattle, WA (US)

(21) Appl. No.: 17/327,749

(22) Filed: May 23, 2021

Related U.S. Application Data
(63) Continuation-in-part of application No. 17/013,766, filed on Sep. 7, 2020, now abandoned.

(51) Int. Cl. H05H 1/10; H01F 6/04; H01F 6/06

(52) U.S. Cl. CPC H05H 1/10; H01F 6/06; H01F 6/04

(57) ABSTRACT

One or more embodiments of a device for generating a magnetic field. The device may include a chamber and a first magnetic field generator. The magnetic field generator may include a plurality of solenoid capsules. Each of the solenoid capsules may include a shell and a solenoid. Each shell may encapsulate the respective solenoid of the solenoid capsule of the shell. The first magnetic field generator may encircle a first portion of the chamber.

### CROSS REFERENCE TO RELATED APPLICATIONS

This application is a continuation in part which claims priority to Application No. 17/013,766, which was filed Sep. 7, 2020, which is incorporated in its entirety.

### FIELD OF THE DISCLOSURE

The present invention relates to devices for generating magnetic fields. In particular the present invention is related to devices for generating magnetic fields in a torus shaped chamber.

### BACKGROUND

Torus shaped chambers/tunnels have been used in particle accelerators and fusion reactors. In these chambers, charged particles are sent around the torus at high speed. In order to prevent (or reduce the likelihood) the particles from slamming into the walls of the chamber, a magnetic field is used to keep the particles near the center of the torus and away from the sides of the chamber.

In most fusion reactors, huge unitary solenoids (several meters high) may be wrapped perpendicularly (or also diagonally in the case of a stellarator) around the torus shaped chamber and may generate a magnetic field in the chamber by running an enormous amount of electricity through the solenoids. This process generates a large amount of heat generated from the resistance of the solenoid to the electric current. Wires generally increase in resistance as the temperature of the wire increases. Accordingly, the longer the solenoid is used the lower the magnetic field generated per volt and the greater amount of energy that is wasted to maintain the magnetic field strength.

Recent improvements in superconductivity have made it possible to have near zero resistance conduction of electricity. However, the high efficiency superconducting material must be maintained at a very low temperature (the exact temperature is different for each superconducting material) to maintain its superconducting material properties.

Cooling an area large enough to have a several meter high solenoid such as those currently used in fusion reactors would be expensive and it would be difficult to safely maintain at the low temperature needed for superconductive materials to maintain their superconductive properties.

### SUMMARY

One or more embodiments of a device for a device for generating a magnetic field is disclosed. The device may include a chamber and a first magnetic field generator. The magnetic field generator may include a plurality of solenoid capsules. Each of the solenoid capsules may include a shell and a solenoid. Each shell may encapsulate the respective solenoid of the solenoid capsule of the shell. The first magnetic field generator may encircle a first portion of the chamber.

The device may provide significant advantages over the devices known in the art. The device may generate a magnetic field using far less power than current techniques. Further, the device may be controlled to generate magnetic fields of various shapes for improved plasma control. Also, the component parts of the device may be modularly replaced causing maintenance costs to be significantly reduced.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an example top view of a device 1000.

FIG. 2 shows an example cross section view of a magnetic field generator including a first ring.

FIG. 3 shows an example cross section view of a second ring on a support ring.

FIG. 4 shows an example cross section view of a solenoid capsule on the second ring.

FIG. 5 shows an example schematic diagram of the electric and cooling connections.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

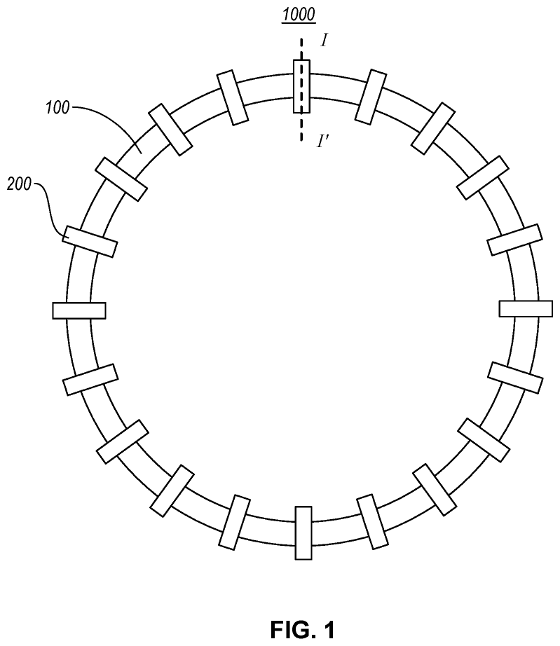

FIG. 1 shows an example top view of a device 1000. The device may include a chamber 100 and magnetic field generators 200. The magnetic field generators 200 may each encircle a portion of the chamber 100 and may be interspersed at regular intervals around the chamber 100. The chamber 100 may be a containment chamber for plasma or other material in a fusion reactor or particle accelerator. The chamber 100 may be lined with tungsten, an alloy of tungsten, or other material capable of withstanding proximate temperatures of around 100,000 degrees. The chamber 100 may have a major radius of about 8 or more meters and a ratio of major to minor radius of about 3 or more. Ordinary air may be removed from chamber 100 when fusion or particle acceleration is occurring in chamber 100. The chamber 100 may have a ring shape in a first plane. Each magnetic field generator 200 may encircle and form a ring shape around a portion of the chamber 100 in a second plane perpendicular to the first plane. Each of the second rings may form a second ring shape in a plurality of third planes perpendicular to the second plane of the respective first ring 210 of the second ring 300.

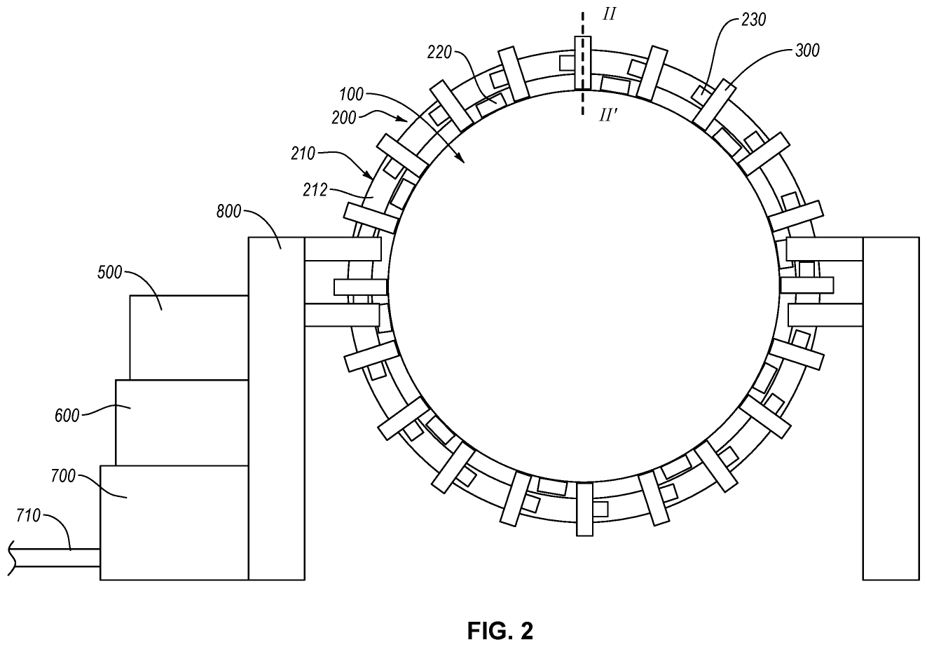

FIG. 2 shows an example cross section view of a magnetic field generator 200 including a first ring 210. FIG. 2 is a cross section view of FIG. 1 at the line I-I′. The magnetic field generator 200 may include the first ring 210, controller 500, a cooling device 600, and a power supply unit 700. The magnetic field generator 200 may also include a support structure 800 supporting the first ring on and around the chamber 100.

The first ring 210 may include a support ring 212, actuators 230, and second rings 300. The second ring 300 may be supported by supports 220 between the chamber 100 and the second ring 300. Each second ring 300 may have an actuator 230 configured to rotate the second ring 300. The actuators 230 may include electric motors, gearing, and other similar devices for moving devices. Electric and coolant connections (not shown in this figure) between the controller 500, cooling device 600, and power supply device 700 and the actuators 230 and solenoid capsules 400 included in the second rings 300 may pass through the support ring 212. The electric and coolant connections connected to the solenoid capsules 400 may have extra length so that the second ring 300 can rotate 360 degrees without disconnecting the connections.

The supports 220, support ring 210, and support structure 800 may be made of a durable material such as steel, plastic, or composite that can withstand the weight of various components they support as well as the magnetic fields generated by the second rings 210.

As will be discussed in greater detail below, the controller 500 may control the components of the magnetic field generator 200. The cooling device 600 may cool solenoid capsules 400 in the second rings 300. The power supply unit 700 may supply power to the components of the magnetic field generator 200. The power supply unit 700 may generate power itself (for example a generator) or may receive power from an outside source such as a power grid (not shown). The power supply unit 700 may have cables 710 connecting the power supply unit to power supply such as an electric grid (not shown). The power supply unit 700 may convert electrical currents and/or voltages (e.g., AC/DC conversion, voltage conversion, current rectification, etc).

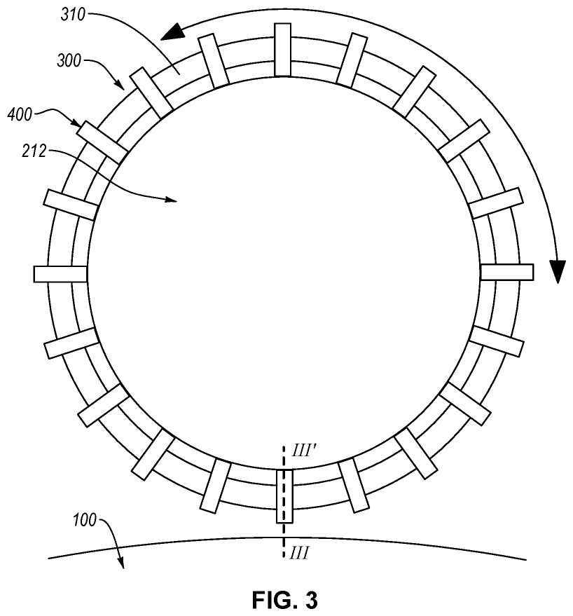

FIG. 3 shows an example cross section view of a second ring 300 on a first ring. FIG. 3 is a cross section view of FIG. 2 at the line II-IF . The second ring 300 may include a support ring 310 and a plurality of solenoid capsules 400 around the support ring 310. The solenoid capsules 400 and support ring 310 may be able to be rotated around the support ring 212 of the first ring 210. The support ring 310 may be made of a non-magnetic, non-conducting material such as plastic, ceramic, or composite that will affect the magnetic field generated by the solenoids 410 in the solenoid capsules 400 less than a conducting, magnetic material. The support ring 310 may pass through the solenoid capsules 400 or may connect between the solenoid capsules 400 (i.e., be made up of several pieces connected between the solenoid capsules).

The magnetic field generator 200 may include a plurality of solenoid capsules 400. Each magnetic field generator encircles a portion of the chamber. The second rings 210 of solenoid capsules may be arranged around the chamber 100. The second rings 210 may be evenly spaced around the camber 100.

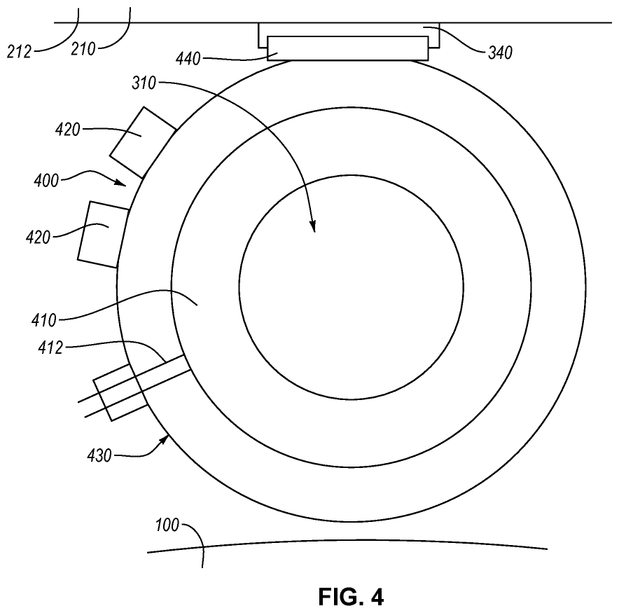

FIG. 4 shows an example cross section view of a solenoid capsule 400 on the support ring 310. FIG. 4 is a cross section view of FIG. 3 at the line The solenoid capsule 400 may include a solenoid 410, leads 412, coolant openings 420 and connector 440. The leads 412 may be wires that connect the solenoid 410 to the power source unit 700 (not shown in this figure). A rail 340 may be connected to the support ring 212 of the first ring 210. The connector 440 of each solenoid capsule 400 may connect to the rail 340 and be able to move along the rail when the actuator 230 is actuated. The solenoid capsule 400 closest to the chamber 100 may be very close to (sometime within 1 inch) chamber 100.

The shell 430 may surround or otherwise encapsulate solenoid 410. The solenoid may include a super conductive material wrapped many times around the support ring 310. A current passing through the supper conductor may generate a magnetic field. Not all of the solenoids 410 may be activated at the same time. For example, only solenoids on the bottom half, or alternatively, within 45 degrees of the bottom (e.g., direction toward the chamber 100) of the second ring 300 may be activated so that the magnetic fields generated by the solenoids 410 may add to generate a large magnetic field in the chamber 100.

Barium Copper Oxide has super conductivity properties at 92 degrees kelvin which is above the boiling point of liquid nitrogen (77 degrees kelvin). Accordingly, a super conductor like Barium Copper Oxide may be used in the solenoid 410 and cooled using liquid nitrogen to maintain its superconductivity even with large amounts of current moving through the material. As more superconductors are discovered, it may be possible to cool these superconductors with other materials, such as super cooled air. Liquid nitrogen generally must be kept at least 22 psi to prevent it from boiling. Accordingly, the tubing and shells 430 of the solenoid capsules 400 should be capable of withstanding temperatures of 77 degrees kelvin and pressures of 22 psi. Polyethylene or metal tubing may be used to connect the solenoid capsules 400 to the cooling device 600. Polyethylene is non-magnetic and non-conductive so it will affect the magnetic fields generated by the solenoid 410 minimally. Accordingly, it may be preferable to make the shell 430 and any tubing for transporting a coolant such as liquid nitrogen of polyethylene or another material with similar properties.

The coolant openings 420 may allow coolant such as liquid nitrogen to enter and leave the shell 430. For example, coolant may enter through one coolant opening 420 and leave through a second coolant opening 420. The coolant may be cycled using the cooling device 600 when the solenoid 410 is in use (i.e., generating a magnetic field) to maintain the solenoid 410 at a temperature where the materials of the solenoid 410 have super conductive properties.

The solenoid capsules 400 may be removable/modular/detachable from the support ring 310 either by opening/disconnecting the support ring 310 or through another function such that the solenoid capsules can be replaced. This greatly reduces the work needed for repairing the magnetic field generator 200 if one of the solenoids capsules 400 is broken or underperforming.

The support ring 210 may have a round cross-sectional shape. Alternatively, in order to have more of the solenoids 410 generating a magnetic field directed at an angle closer to parallel with the outside of the chamber 100, the support ring 210 may have an elongated oval or even flat shape on the side closest to the chamber 100. However, this elongated or flat cross-sectional shape of the support ring 210 makes it more very difficult to use a rigid support ring 310 and rotate the solenoid capsules around the support ring 210. Accordingly, when the support ring 210 has a cross section that is not round either the actuator 230 and rotation feature of the support ring 210 or the support ring 210 may not be included.

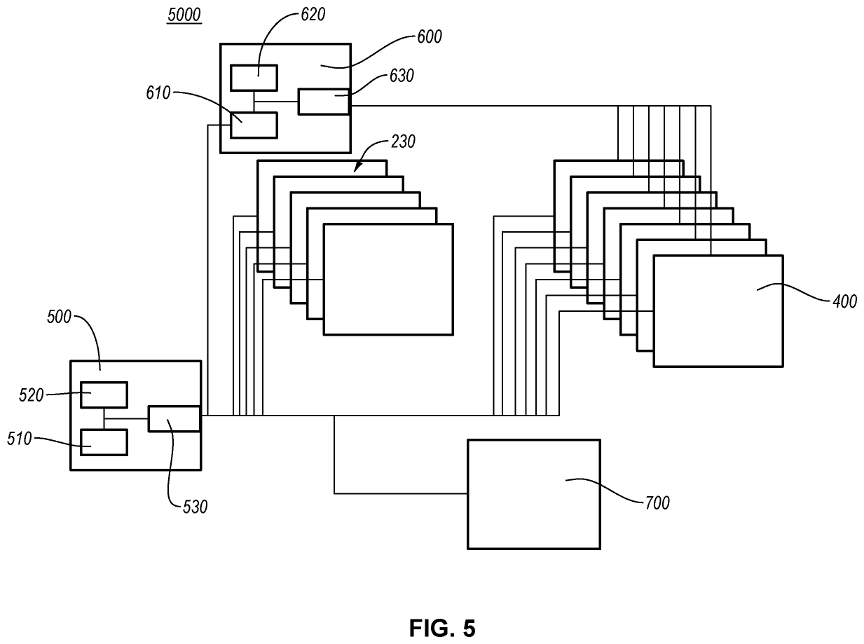

FIG. 5 shows an example schematic diagram of the electric and cooling connections.

The controller 500 may include a memory 510, processor 520, and interface hardware 530. The memory 510 may include instructions for controlling the magnetic field generator 200. The processor 520 may be configured to read the instructions stored on memory 510 and execute the instructions to control the magnetic field generator 200. The interface hardware 530 may send instructions to other components of the magnetic field generating device 200, including through wired and wireless communication. The interface hardware 530 may also have hardware for communicating with other devices such as a central controller (not shown) to receive information and instructions, or to send information and instructions. The interface hardware 530 may also receive power from the power supply unit 700. The memory 510 may include volatile and/or non-volatile memory. The processor 520 may be a central processing unit, or other form of processing hardware. The interface hardware 530 may include wired and wireless communication hardware, power conversion hardware, and any other hardware necessary for the interface functions described herein. The controller 500 may include shielding such as aluminum plates to protect the electronics from the large magnetic field generated from the solenoids 400.

The power supply unit 700 may provide power to the controller 500, the cooling device 600, the actuators 530 and the solenoids 410 in the solenoid capsules 400. The controller 500 may control how power is distributed by the power supply unit 700. Hardware to supply or cut off power to individual components may be within the power supply unit 700, the processor 500, or the other components. The hardware to supply or cut off power may be switches or gates (not shown) that are activated based on instructions from the processor 520.

The cooling device 600 may include a controller 610, an actuator 620, and a coolant reservoir 630. The actuator 620 may be configured to cause coolant from the coolant reservoir 630 to be circulated through the solenoid capsules 400. The controller 610 may be configured to control the actuator 620 based on instructions received from the controller 500. The controller 610 and actuator 620 may receive power from the power supply unit 700. The coolant reservoir 630 may include cooling hardware configured to maintain a temperature of the coolant at a desired temperature. Alternatively, the coolant reservoir 630 could be a liquid nitrogen generator used to generate liquid nitrogen and the actuator 620 may pump the liquid nitrogen to the solenoid capsules 400.

The actuators 230 may rotate the second rings 300 either clockwise or counter-clockwise, based on instruction from the controller 500. The solenoids 410 in the solenoid capsules 400 may be operated at several different power levels to generate a magnetic field of different magnitudes. Accordingly, the controllers 530 may create magnetic fields of various shapes and magnitudes in the chamber 100 using the solenoids 400. This is advantageous because it is difficult to maintain plasma with a straight magnetic field in a torus shaped chamber and this invention allows the magnetic field to be adjusted to improve magnetic fields for maintaining plasma in a fusion reactor chamber.

Many different embodiments of the inventive concepts have been shown. A person of ordinary skill in the art will appreciate that the features from different embodiments may be combined or replaced with other features from different embodiments.

Advantageously, the device 1000 allows for large magnetic fields to be generated in a chamber 100 using super conductors that are maintained at a temperature where the super conductors have super conductive properties. Also advantageous, the shape and magnitude of the magnetic field can be controlled and adjusted to provide for better plasma retention/generation. Also, the device 1000 had improved repairability because individual solenoid capsules 400 can be removed (or rotated to a position where they are not in use) if the solenoid capsule 400 is broken or underperforming.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A device comprising
a chamber; and
a first magnetic field generator, wherein the magnetic field generator includes a plurality of solenoid capsules, wherein each of the solenoid capsules of the plurality of solenoid capsules includes a shell and a solenoid, wherein each shell encapsulates the respective solenoid of the solenoid capsule of the shell, and wherein the first magnetic field generator encircles a first portion of the chamber.

2. The device of claim 1, further comprising,
A second magnetic field generator, wherein the second magnetic field generator encircles a second portion of the chamber.

3. The device of claim 1, wherein the chamber has a ring shape in a first plane, and the first magnetic field generator encircles the first portion of the chamber in a second plane perpendicular to the first plane.

4. The device of claim 3, wherein each of the solenoid capsules of the plurality of solenoid capsules for the first magnetic field generator are arranged in rings, wherein each ring of the rings extends in a direction perpendicular to the second plane.

5. The device of claim 1, wherein the rings of the plurality of solenoid capsules are arranged around the chamber.

6. The device of claim 5, further comprising:
a plurality of actuators, wherein each actuator of the plurality of actuators is arranged to rotate one of the rings of solenoid capsules.

7. The device of claim 1, further comprising:
a power supply configured to supply power to each of the solenoids of the first magnetic field generator; and
a cooling device configured to cool each of the solenoid capsules.

8. The device of claim 7, wherein the solenoids include a material with superconductive properties when cooled by the cooling device.

9. A device comprising:
a chamber with a torus shape, wherein the chamber has a ring shape in a first plane; and
a plurality of first rings encircling portions of the chamber, wherein each of the plurality of first rings include a plurality of second rings, and wherein each of the plurality of second rings include a plurality of solenoids, wherein each of the plurality of first rings passes through a center of the torus shape of the chamber, wherein each of the first rings forms a first ring shape in a plurality of second planes perpendicular to the first plane, wherein each of the second rings forms a second ring shape in a plurality of third planes perpendicular to the second plane of the respective first ring of the second ring.

10. The device of claim 3 wherein each second ring includes a plurality of solenoid capsules each including a shell and one of the solenoids, wherein each of the solenoids is encapsulated by the respective shell of the solenoid capsule.

11. The device of claim 10, further comprising:
a plurality of actuators, wherein each actuator is arranged to rotate one of the second rings.

12. The device of claim 11, further comprising:
a power supply configured to supply power to each of the solenoids of the plurality of solenoids and each of the actuators of the plurality of actuators; and
a cooling device configured to cool each solenoid capsule of a plurality of the solenoid capsules.

13. The device of claim 12, wherein the solenoids of the plurality of solenoids include a material with superconductive properties when cooled by the cooling device.
